(19) United States
(12) Patent Application Publication
(10) Pub. No.: US 2023/0029431 A1
(43) Pub. Date: Jan. 26, 2023

(54) DYNAMIC GAMMA CURVE USE FOR DISPLAY

(71) Applicant: QUALCOMM Incorporated, San Diego, CA (US)

(72) Inventors: Yongjun XU, Beijing (CN); Menghao JIA, Shenzhen (CN); Nan ZHANG, Beijing (CN); Zhizhou CHEN, Shanghai (CN); Xinchao YANG, Shanghai (CN); Daiou ZENG, Shenzhen (CN); Zhibing ZHOU, Shenzhen (CN)

(21) Appl. No.: 17/758,214

(22) PCT Filed: Jan. 31, 2020
(86) PCT No.: PCT/CN2020/074106

§ 371 Date: Jun. 29, 2022

(51) Int. Cl. G09G 5/10; G06V 40/13

(52) U.S. Cl. CPC G09G 5/10; G06V 40/1318; G09G 2320/0673; G09G 2320/0626

(57) ABSTRACT

Method and apparatus for selecting a gamma curve used by a display driver circuit for converting code words provided by a display processing unit to brightness levels based on an operating mode of the computing device. For example, the display processing unit provides code words to the display driver circuit for driving output at a display. Further, the display driver circuit converts the provided code words to analog signal for driving output at the display based on the selected gamma curve.

### TECHNICAL FIELD

The present disclosure relates generally to processing systems and, more particularly, to one or more techniques for display or graphics processing.

### BACKGROUND

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution.

Portable computing devices, including smartphones, tablets, and wearable devices, may present graphical content on a display. In certain situations, it may be desirable to dim all or a portion of the display of a computing device, meaning it may be desirable to reduce a brightness (also referred to as luminance) of all or a portion of the display. For example, pixels (e.g., red, green, blue, white, etc.) of the display may be configured to emit light at a reduced brightness in order to dim the display.

In some cases, dimming the display may cause issues such as producing banding artifacts on the display, which is not desirable as it leads to a compromised user experience. Banding artifacts occur where the transition between different colors on different portions of a display are not smooth. Accordingly, techniques for dimming that avoid such issues are desirable.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

Certain aspects of the present disclosure provide a method for displaying images by a computing device. The method includes selecting a gamma curve used by a display driver circuit for converting code words provided by a display processing unit to brightness levels based on an operating mode of the computing device. The gamma curve is selected from a plurality of gamma curves. The operating mode is one of a dimmed mode or a non-dimmed mode. When the operating mode is the dimmed mode, the selected gamma curve comprises a first value gamma curve. When the operating mode is the non-dimmed mode, the selected gamma curve comprises a second value gamma curve, wherein the first value is higher than the second value. The method includes providing, by the display processing unit, code words to the display driver circuit for driving output at a display. The method includes converting, by the display driver circuit, the provided code words to analog signal for driving output at the display based on the selected gamma curve.

Certain aspects of the present disclosure provide a computing device including a display. The computing device further includes a display driver circuit configured to convert code words to analog signals for driving output at the display. The computing device further includes a display processing unit configured to provide code words to the display driver circuit for driving output at the display. The computing device further includes circuitry. The circuitry is configured to select a gamma curve used by the display driver circuit for converting code words provided by the display processing unit to brightness levels based on an operating mode of the computing device. The gamma curve is selected from a plurality of gamma curves. The operating mode is one of a dimmed mode or a non-dimmed mode. When the operating mode is the dimmed mode, the selected gamma curve comprises a first value gamma curve. When the operating mode is the non-dimmed mode, the selected gamma curve comprises a second value gamma curve, wherein the first value is higher than the second value.

Certain aspects of the present disclosure provide a computing device comprising means for displaying. The computing device further includes means for converting code words to analog signals for driving output at the means for displaying. The computing device further includes means for providing code words to the means for converting for driving output at the means for displaying. The computing device further includes means for selecting a gamma curve used by the means for converting for converting code words provided by the means for providing to brightness levels based on an operating mode of the computing device. The gamma curve is selected from a plurality of gamma curves. The operating mode is one of a dimmed mode or a non-dimmed mode. When the operating mode is the dimmed mode, the selected gamma curve comprises a first value gamma curve. When the operating mode is the non-dimmed mode, the selected gamma curve comprises a second value gamma curve, wherein the first value is higher than the second value.

Certain aspects of the present disclosure provide a non-transitory computer-readable medium that when executed by a computing device causes the computing device to perform a method of displaying images by the computing device. The method includes selecting a gamma curve used by a display driver circuit for converting code words provided by a display processing unit to brightness levels based on an operating mode of the computing device. The gamma curve is selected from a plurality of gamma curves. The operating mode is one of a dimmed mode or a non-dimmed mode. When the operating mode is the dimmed mode, the selected gamma curve comprises a first value gamma curve. When the operating mode is the non-dimmed mode, the selected gamma curve comprises a second value gamma curve, wherein the first value is higher than the second value. The method includes providing, by the display processing unit, code words to the display driver circuit for driving output at a display. The method includes converting, by the display driver circuit, the provided code words to analog signal for driving output at the display based on the selected gamma curve.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram that illustrates an example content generation system, in accordance with one or more techniques of this disclosure.

FIG. 2 illustrates both a gamma curve 2.2 and a gamma curve 4.0.

FIG. 3 illustrates example operations for a device entering a dimming mode and exiting a non-dimming mode, according to certain aspects of the present disclosure.

FIG. 4 illustrates example operations for a device exiting a dimming mode and entering a non-dimming mode, according to certain aspects of the present disclosure.

FIG. 5 illustrates example operations for adjusting the gamma curve used for displaying an image based on an operating mode of a device, according to certain aspects of the present disclosure.

### DETAILED DESCRIPTION

In general, aspects disclosed herein provide techniques for improving visual quality of display images presented on a display when the display is dimmed. For example, using conventional techniques, display images presented on a display when dimmed may suffer from banding artifacts, such as due to a reduced number of available brightness levels in a dimmed display that are below a threshold brightness level. Example techniques disclosed herein improve on such conventional techniques by adjusting the gamma curve used to generate the display image to provide a greater number of available brightness levels in a dimmed display that are below the threshold brightness level.

In some examples, dimming is achieved by applying a dimming layer to the display, where the dimming layer is a type of frame layer. In some examples, a display processor may perform compositing (or blending) of pixel data from different frame layers to generate a display image for presentment via the display. As used herein, a frame layer (sometimes referred to as a “layer”) refers to a layer that is combined with one or more other frame layers into a single layer (e.g., the display image). A dimming layer may be a flat layer (e.g., all black) with a certain opacity/transparency that is overlaid on one or more other frame layers such that when combined with the one or more other frame layers into a single layer, the overall brightness of the one or more other frame layers is reduced.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, examples disclosed herein provide techniques for adjusting the gamma curve used to generate a display image for a display to provide a greater number of available brightness levels in a dimmed display that are below a threshold brightness level. Examples techniques may improve visual quality of display images presented on a display when the display is dimmed. For example, this disclosure describes techniques for graphics and/or display processing in any device that utilizes a display. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to content produced by one or more processes of a graphics processing pipeline. In some examples, as used herein, the term “graphical content” may refer to content produced by a processing unit configured to perform graphics processing. In some examples, as used herein, the term “graphical content” may refer to content produced by a graphics processing unit.

In some examples, as used herein, the term “display content” may refer to content generated by a processing unit configured to perform display processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

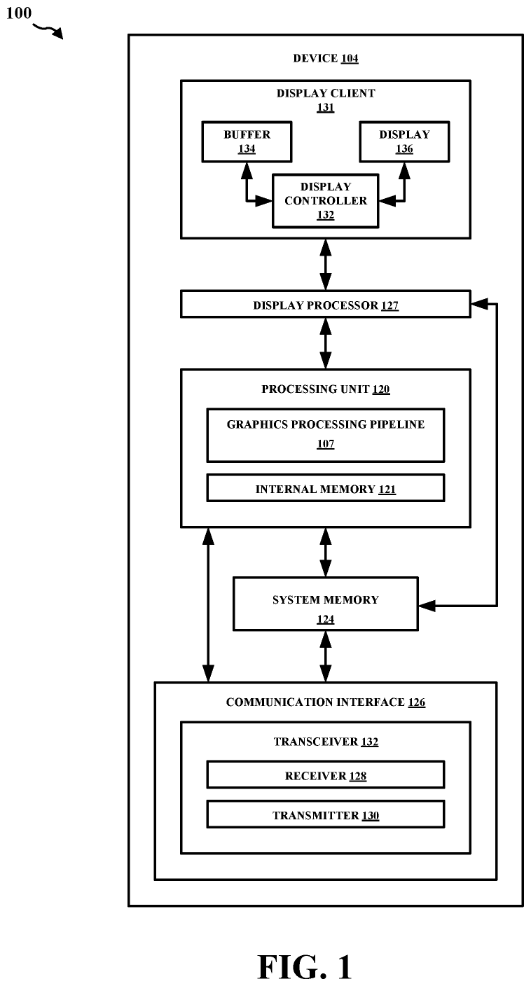

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120 and a system memory 124. In some examples, the device 104 can include a number of additional or alternative components, e.g., a communication interface 126, a transceiver 132, a receiver 128, a transmitter 130, a display processor 127, and a display client 131. Reference to the display client 131 may refer to one or more displays. For example, the display client 131 may include a single display or multiple displays. The display client 131 may include a first display and a second display. In further examples, the results of the graphics processing may not be displayed on the device, e.g., the first and second displays may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. In some examples, the device 104 may include a display processor, such as the display processor 127, to perform one or more display processing techniques on one or more frames generated by the processing unit 120 before presentment by the display client 131. The display processor 127 may be configured to perform display processing. For example, the display processor 127 may be configured to perform one or more display processing techniques on one or more frames generated by the processing unit 120. The display processor 127 may output image data to the display client 131 according to an interface protocol, such as, for example, the MIPI DSI (Mobile Industry Processor Interface, Display Serial Interface).

The display client 131 may be configured to display or otherwise present frames processed by the display processor 127. In some examples, the display client 131 may include one or more of: a liquid crystal display (LCD), a plasma display, an organic light emitting diode (OLED) display, a projection display device, an augmented reality display device, a virtual reality display device, a head-mounted display, or any other type of display device.

In the illustrated example of FIG. 1, the display client 131 includes a display controller 132, a buffer 134, and a display 136. The example display 136 includes a plurality of pixel elements for displaying image data. The display controller 132 may receive image data from the display processor 127 and store the received image data in the buffer 134. In some examples, the display controller 132 may output the image data stored in the buffer 134 to the display 136. Thus, the buffer 134 may represent a local memory to the display client 131. In some examples, the display controller 132 may output the image data received from the display processor 127 to the display 136.

Furthermore, as disclosed above, the display client 131 may be configured in accordance with MIPI DSI standards. The MIPI DSI standard supports a video mode and a command mode. In examples where the display client 131 is operating in video mode, the display processor 127 may continuously refresh the graphical content of the display client 131. For example, the entire graphical content may be refreshed per refresh cycle (e.g., line-by-line).

In examples where the display client 131 is operating in command mode, the display processor 127 may write the graphical content of a frame to the buffer 134. In some such examples, the display processor 127 may not continuously refresh the graphical content of the display client 131. Instead, the display processor 127 may use a vertical synchronization (Vsync) pulse to coordinate rendering and consuming of graphical content at the buffer 134. For example, when a Vsync pulse is generated, the display processor 127 may output new graphical content to the buffer 134. Thus, the generating of the Vsync pulse may indicate when current graphical content at the buffer 134 has been rendered.

Memory external to the processing unit 120, such as system memory 124, may be accessible to the processing unit 120. For example, the processing unit 120 may be configured to read from and/or write to external memory, such as the system memory 124. The processing unit 120 may be communicatively coupled to the system memory 124 over a bus. In some examples, the processing unit 120 and the system memory 124 may be communicatively coupled to each other over the bus or a different connection.

It should be appreciated that in some examples, the device 104 may include a content encoder/decoder configured to receive graphical and/or display content from any source, such as the system memory 124 and/or the communication interface 126. The system memory 124 may be configured to store received encoded or decoded content. In some examples, the content encoder/decoder may be configured to receive encoded or decoded content, e.g., from the system memory 124 and/or the communication interface 126, in the form of encoded pixel data. In some examples, the content encoder/decoder may be configured to encode or decode any content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

In some examples, the graphical content from the processing unit 120 for display via the display client 131 is not static and may be changing. Accordingly, the display processor 127 may periodically refresh the graphical content displayed via the display client 131. For example, the display processor 127 may periodically retrieve graphical content from the system memory 124, where the graphical content may have been updated by the execution of an application (and/or the processing unit 120) that outputs the graphical content to the system memory 124.

It should be appreciated that while shown as separate components in FIG. 1, in some examples, the display client 131 (sometimes referred to as a “display panel”) may include the display processor 127.

Referring again to FIG. 1, in certain aspects, the display processor 127 (also referred to as a display processing unit (DPU)) may be configured to operate functions of the display client 131. For example, in certain aspects, the display processor 127 is configured to output a plurality of code words, such as corresponding to a frame, to the display controller 132. Each code word may be represented by a binary number in the digital domain. Each code word may correspond to a pixel (e.g., red, green, blue, white, etc.) of the display 136.

The display controller 132 may be configured to convert the code words received from the display processor 127 to analog signals used to drive the pixels of the display 136. In certain aspects, for each code word corresponding to a pixel, the display controller 132 is configured to convert the code word to an analog signal(s) that drives the pixel to a particular brightness level. Accordingly, in certain aspects, the code word and/or analog signal(s) correspond to a brightness level for the pixel.

In certain aspects, the display controller 132 is configured to utilize a gamma curve to convert a code word to one or more analog signals for driving a display. The gamma curve correlates or maps a code word to a particular brightness level for a pixel.

In certain aspects, the display controller 132 is configured with a plurality of gamma curves. Accordingly, in certain aspects, the display controller 132 can be configured to use a different one of the plurality of gamma curves at different times. For example, as described herein, the display controller 132 can be configured to utilize different gamma curves for different operating modes of the device 104.

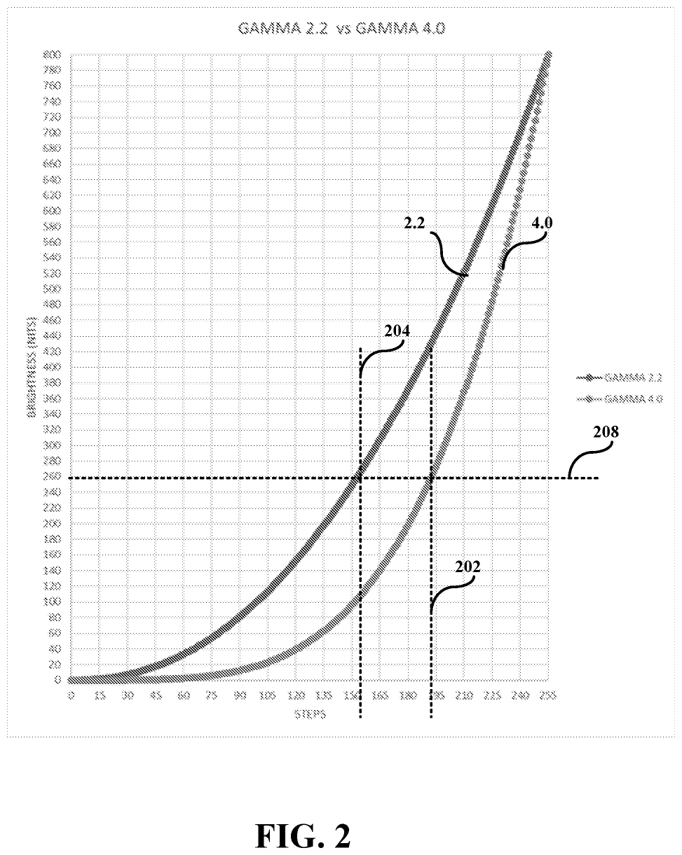

In certain aspects, different gamma curves may map one or more code words to different brightness levels. For example, FIG. 2 illustrates both a gamma curve 2.2 and a gamma curve 4.0. The x-axis represents code words, and the y-axis represents brightness levels. The gamma curve 4.0 is a higher value, 4.0, than the gamma curve 2.2 value, 2.2. Accordingly, based on the gamma curve used by the display controller 132, the pixels of the display 136 may be driven to different brightness levels even with the same code words received from the display processor 127.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, can be performed using other components (e.g., a CPU), consistent with disclosed embodiments.

In certain aspects, it may be desirable to reduce the luminance of a display panel in the digital domain. For example, it may be desirable to reduce the brightness of all or a portion of the display 136 by performing processing on image data in the digital domain, as opposed to just reducing the brightness strictly in the analog domain.

For example, in certain aspects, the display 136 may include a sensor under a portion of the display 136. In certain aspects, the sensor is one or more of a camera, an optical fingerprint sensor, etc. In certain aspects, when using a fingerprint sensor under the display 136, it may be desirable to increase (e.g., set to maximum) the brightness level of the portion of the display the fingerprint sensor is under in order to provide better conditions for detecting a fingerprint using the fingerprint sensor. Thus, the display 136 may be set to a high brightness mode where the brightness level of the display 136 is increased across the entire display 136, such as in the analog domain. For example, in a high brightness mode, such as for a LCD display, a brightness of a backlight (e.g., LED) of the display may be increased. To put the display 136 in high brightness mode, the processing unit 120 may send an indication to enter high brightness mode to the display processor 127. The display processor 127 may then send an indication to the display controller 132 to drive the display 136 in the high brightness mode.

When in the high brightness mode, as discussed, the image across the entire display 136 is brightened. This may lead to dazzling where the image is very bright and can be uncomfortable for a user to view on the display 136. Accordingly, in certain aspects, the processing unit 120 is configured to overlay a dimming layer on the one or more other frame layers that are used by the display processor 127 to generate the image for display on display 136 in the digital domain. The dimming layer may correspond to the shape of display 136 with a cut-out in the area corresponding to the portion of the display 136 under which is the fingerprint sensor, so as not to dim that portion of the display 136. The dimming layer may have a low transparency (e.g., 20%)/high opacity (e.g., 80%). For example, the dimming layer may have an alpha value corresponding to a high opacity.

Accordingly, when the dimming layer is merged with the one or more other frame layers by the display processor 127, the portions of the image corresponding to the dimming layer have a lower brightness level in the digital domain. Thus, the display processor 127 generates code words corresponding to the pixels corresponding to the area of the dimming layer with lower values corresponding to lower brightness levels as compared to without the dimming layer. The display controller 132 thus drives the pixels in the area corresponding to the dimming layer with a lower brightness level as compared to without the dimming layer.

In another example, the display 136 may be operated in a low light night mode. Conventionally, such a low light night mode may be configured by reducing brightness of the display 136 in the analog domain. For example, for an OLED display, direct current (DC) dimming may be performed on the display 136, where the display controller 132 controls the brightness of the display 136 by varying a power supplied to the display 136, such as using pulse width modulation (PWM). Such dimming in the analog domain, however, may cause flicker of the display 136, which may not be desirable. Accordingly, as discussed, it may be desirable to apply a dimming layer in the digital domain to a portion or all of the display 136 to digitally dim the display 136 and avoid flicker caused by analog dimming alone.

Reducing the brightness level of the display 136 in the digital domain, such as to a desired maximum allowed nit output, however, leads to fewer available code words for use in the digital domain, which can lead to banding on the display 136. In particular, as discussed, the display processor 127 is configured to provide code words corresponding to pixels of display 136 to display controller 132. Further, display controller 132 is configured to use a gamma curve to convert the code words to brightness levels for the pixels of display 136. For the dimmed portion of display 136, the maximum allowed brightness level (nit level) may be set at a particular level. Only a subset of the available code words in the digital domain may correspond to brightness levels that are below the maximum allowed brightness level. Thus, fewer code words than the available code words in the digital domain may be available for use when dimming the display 136.

Since fewer code words are available when performing dimming in the digital domain, fewer brightness levels are available for output at the display 136, which in certain aspects can lead to banding where the transition between colors is not smooth. In certain aspects, the number of available code words below a threshold brightness level is dependent on the gamma curve used by the display controller 132, where a higher value gamma curve may have more available code words for a lower maximum allowed brightness level. For example, as shown in FIG. 2, for a given maximum allowed brightness level 208, there are a greater number of code words 202 that can be used for gamma curve 4.0 that a number of code words 204 that can be used for gamma curve 2.2. A larger number of available code words in the digital domain means a larger number of brightness levels are available for output at the display 136, which in certain aspects can reducing banding.

Accordingly, certain aspects herein adjust the gamma curve used by the display controller 132, such as based on an operating mode of the device 104. For example, the device 104 may operate in a dimmed mode or a non-dimmed mode. In the dimmed mode, a dimming layer is applied to one or more frame layers by processing unit 120, as discussed. In the non-dimmed mode, a dimming layer is not applied by the processing unit 120. In certain aspects, the processing unit 120 selects a higher value gamma curve for use by the display controller 120 when operating in the dimmed mode, and a lower value gamma curve when operating in the non-dimmed mode. The processing unit 120 may be configured to indicate the selected gamma curve to the display processor 127, which indicates the selected gamma curve to the display controller 132 for use.

Thus, when in the dimmed mode, the display controller 132 uses a higher value gamma curve, meaning the display processor 127 can use a larger number of code words for representing images for display on display 136. Therefore, the display processor 127 can select from a larger number of brightness levels for images for display when in the dimmed mode, and thus there is reduced banding on display 136.

In one example case, if the maximum allowed brightness level of display 136 is set to 2 nits, and the display 136 is operating in a high brightness mode, the alpha of the dimming layer may need to be set to 16 when the display controller 132 is using a gamma curve 2.2. Accordingly, the range of code words available to meet the 2 nit level is reduced from [0, 255] to [0, 15], and serious banding may be seen on display 136.

However, using aspects discussed herein, if the maximum allowed brightness level of display 136 is still set to 2 nits, and the display 136 is operating in a high brightness mode, but the display controller 132 is using a gamma curve 4.0 instead of 2.2, the alpha of the dimming layer can be increased to 57. Accordingly, the range of code words available to meet the 2 nit level is reduced from [0, 255] to [0, 56], as opposed to [0, 15], meaning the banding issue is reduced.

In certain aspects, processing unit 120 is configured to operate device 104 in a dimmed mode while performing fingerprint verification and/or DC dimming of display 136. In certain aspects, processing unit 120 is configured to operate device 104 in non-dimmed mode when not performing fingerprint verification and/or DC dimming of display 136.

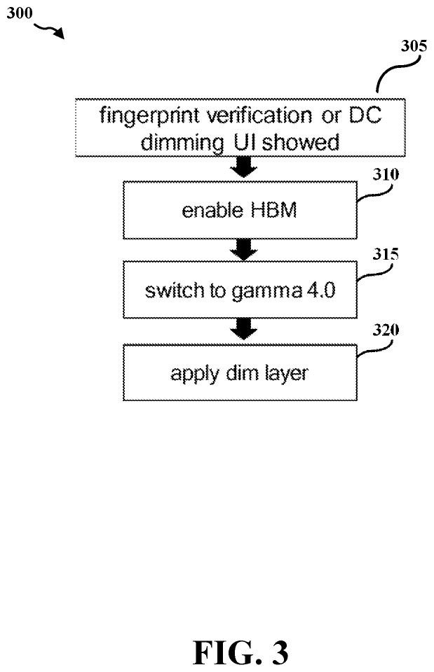

FIG. 3 illustrates example operations 300 for device 104 entering a dimming mode and exiting a non-dimming mode. At step 305, processing unit 120 determines that fingerprint verification or DC dimming is being initiated. At step 310, processing unit 120 enables high brightness mode. Further, at step 315, processing unit 120 configures display controller 132 to utilize a higher value gamma curve, such as gamma curve 4.0. At step 320, processing unit 120 provides a dimming layer to display processor 127. Thus, the display 136 is dimmed as discussed.

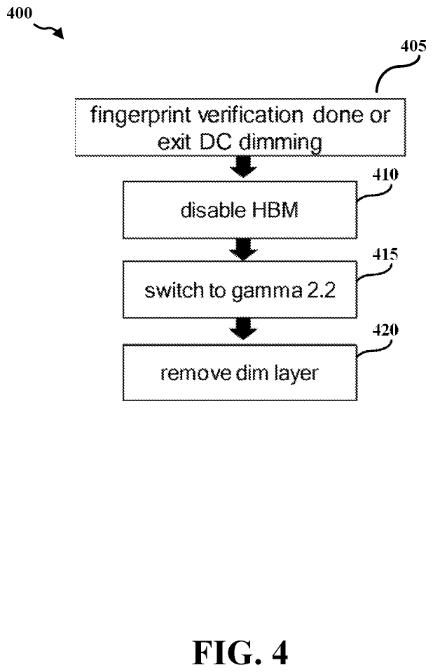

FIG. 4 illustrates example operations 400 for device 104 exiting a dimming mode and entering a non-dimming mode. At step 405, processing unit 120 determines that fingerprint verification or DC dimming is complete. At step 410, processing unit 120 disables high brightness mode. Further, at step 415, processing unit 120 configures display controller 132 to utilize a lower value gamma curve, such as gamma curve 2.2. At step 420, processing unit 120 no longer provides a dimming layer to display processor 127. Thus, the display 136 is no longer dimmed as discussed.

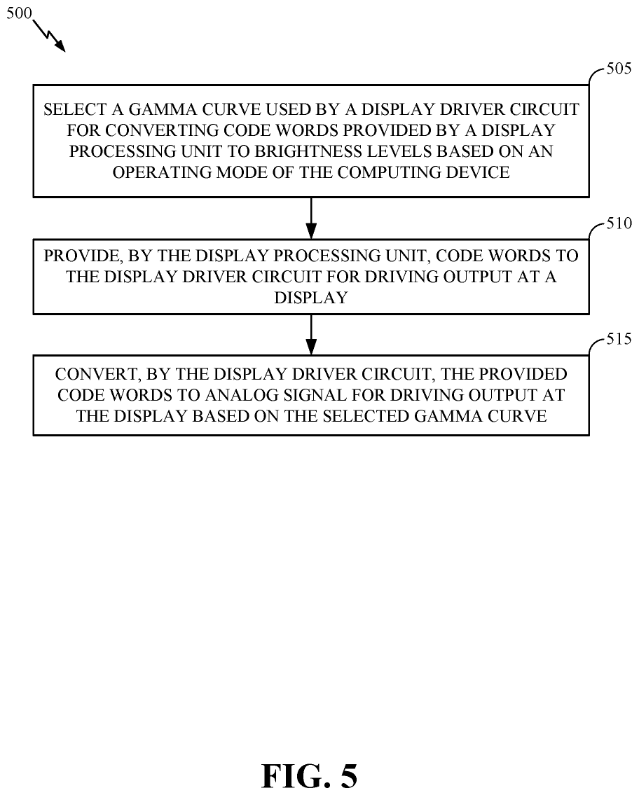

FIG. 5 illustrates example operations 500 for adjusting the gamma curve used for displaying an image based on an operating mode of a device, such as device 104, according to certain aspects of the present disclosure. In certain aspects, the device includes a display, such as display 136. In certain aspects, the device includes a display driver circuit, such as display controller 132. In certain aspects, the display driver circuit is configured to convert code words to analog signals for driving output at the display. In certain aspects, the device includes a display processing unit, such as display processor 127. In certain aspects, the display processing unit is configured to provide code words to the display driver circuit for driving output at the display. In certain aspects, the device includes circuitry, such as processing unit 120.

At 505, the circuitry selects a gamma curve used by the display driver circuit for converting code words provided by the display processing unit to brightness levels based on an operating mode of the computing device. The gamma curve is selected from a plurality of gamma curves. The operating mode is one of a dimmed mode or a non-dimmed mode. When the operating mode is the dimmed mode, the selected gamma curve comprises a first value gamma curve. When the operating mode is the non-dimmed mode, the selected gamma curve comprises a second value gamma curve, wherein the first value is higher than the second value.

At 510, the display processing unit generates and/or provides code words for displaying an image on the display 136. The code words are generated based on the desired brightness level for each pixel of the display 136, which is based on the selected gamma curve.

At 515, the display controller 132 utilizes the selected gamma curve to convert the generated code words to analog signals to drive the pixels of the display 136 at brightness levels corresponding to the code words based on the selected gamma curve.

In certain aspects of operations 500, the first value gamma curve maps a first plurality of code words to brightness levels less than a threshold and the second value gamma curve maps a second plurality of code words to brightness level less than the threshold, and a number of the first plurality of code words is greater than a number of the second plurality of code words.

In certain aspects of operations 500, the first value gamma curve maps a first plurality of code words to brightness levels less than a threshold and the second value gamma curve maps a second plurality of code words to brightness level less than the threshold, wherein a number of the first plurality of code words is greater than a number of the second plurality of code words.

In certain aspects of operations 500, the display further comprises a fingerprint sensor in a first area of the display. Further, the operations 500 further include determining a fingerprint verification procedure using the fingerprint sensor is in progress. Further, the operations 500 further include based on determining the fingerprint verification procedure is in progress, selecting the operating mode of the computing device to be the dimmed mode.

In certain aspects of operations 500, the operations 500 further include determining the fingerprint verification procedure is complete. Further, the operations 500 further include based on determining the fingerprint verification procedure is complete, selecting the operating mode of the computing device to be the non-dimmed mode.

In certain aspects of operations 500, in the dimmed mode, a dimming layer is applied to the display, and wherein in the non-dimed mode, the dimming layer is not applied to the display.

In certain aspects of operations 500, the display supports direct current dimming. Further, the operations 500 further include determining direct current dimming of the display is in progress. Further, the operations 500 further include based on determining the direct current dimming of the display is in progress, selecting the operating mode of the computing device to be the dimmed mode.

In certain aspects of operations 500, the operations 500 further include determining the direct current dimming of the display is complete. Further, the operations 500 further include based on determining the direct current dimming of the display is complete, selecting the operating mode of the computing device to be the non-dimmed mode.

In certain aspects of operations 500, the first value gamma curve is a gamma curve 4.0, and wherein the second value gamma curve is a gamma curve 2.2.

In certain aspects of operations 500, the display processing unit is configured to provide different code words to achieve a desired brightness level of the display based on the operating mode.

In one configuration, a method or apparatus for display processing is provided. The apparatus may be a processing unit, a display processor, a display processing unit (DPU), a GPU), a video processor, or some other processor that can perform display processing. In some examples, the apparatus may be the processing unit 120 within the device 104, or may be some other hardware within the device 104, or another device. The apparatus may include means for displaying. The apparatus further includes means for converting code words to analog signals for driving output at the means for displaying. The apparatus further includes means for providing code words to the means for converting for driving output at the means for displaying. The apparatus further includes means for selecting a gamma curve used by the means for converting for converting code words provided by the means for providing to brightness levels based on an operating mode of the apparatus. The gamma curve is selected from a plurality of gamma curves. The operating mode is one of a dimmed mode or a non-dimmed mode. When the operating mode is the dimmed mode, the selected gamma curve comprises a first value gamma curve. When the operating mode is the non-dimmed mode, the selected gamma curve comprises a second value gamma curve, wherein the first value is higher than the second value.

The subject matter described herein can be implemented to realize one or more benefits or advantages. For instance, the described display and/or graphics processing techniques can be used by a display processor, a display processing unit (DPU), a GPU, or a video processor or some other processor that can perform display processing to implement the improving of visual quality of a dimmed display image presented via a display, such as by reducing banding artifacts. In general, examples disclosed herein provide techniques for adjusting the gamma curve used to generate a display image for a display to provide a greater number of available brightness levels in a dimmed display that are below a threshold brightness level.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices,. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A computing device comprising:
a display;
a display driver circuit configured to convert code words to analog signals for driving output at the display;
a display processing unit configured to provide code words to the display driver circuit for driving output at the display; and
circuitry configured to:
select a gamma curve used by the display driver circuit for converting code words provided by the display processing unit to brightness levels based on an operating mode of the computing device, wherein:
the gamma curve is selected from a plurality of gamma curves,
the operating mode is one of a dimmed mode or a non-dimmed mode,
when the operating mode is the dimmed mode, the selected gamma curve comprises a first value gamma curve; and
when the operating mode is the non-dimmed mode, the selected gamma curve comprises a second value gamma curve, wherein the first value is higher than the second value.

2. The computing device of claim 1, wherein the first value gamma curve maps a first plurality of code words to brightness levels less than a threshold and the second value gamma curve maps a second plurality of code words to brightness level less than the threshold, wherein a number of the first plurality of code words is greater than a number of the second plurality of code words.

3. The computing device of claim 1, wherein:
the display further comprises a fingerprint sensor in a first area of the display, and
the circuitry is configured to:
determine a fingerprint verification procedure using the fingerprint sensor is in progress; and
based on determining the fingerprint verification procedure is in progress, select the operating mode of the computing device to be the dimmed mode.

4. The computing device of claim 3, wherein the circuitry is configured to:
determine the fingerprint verification procedure is complete; and
based on determining the fingerprint verification procedure is complete, select the operating mode of the computing device to be the non-dimmed mode.

5. The computing device of claim 1, wherein in the dimmed mode, a dimming layer is applied to the display, and wherein in the non-dimed mode, the dimming layer is not applied to the display.

6. The computing device of claim 1, wherein:
the display supports direct current dimming, and
the circuitry is configured to:
determine direct current dimming of the display is in progress; and
based on determining the direct current dimming of the display is in progress, select the operating mode of the computing device to be the dimmed mode.

7. The computing device of claim 6, wherein the circuitry is configured to:
determine the direct current dimming of the display is complete; and
based on determining the direct current dimming of the display is complete, select the operating mode of the computing device to be the non-dimmed mode.

8. The computing device of claim 1, wherein the first value gamma curve is a gamma curve 4.0, and wherein the second value gamma curve is a gamma curve 2.2.

9. The computing device of claim 1, wherein the display processing unit is configured to provide different code words to achieve a desired brightness level of the display based on the operating mode.

10. The computing device of claim 1, wherein the circuitry is part of an application processor.

11. A method of displaying images by a computing device, the method comprising:
selecting a gamma curve used by a display driver circuit for converting code words provided by a display processing unit to brightness levels based on an operating mode of the computing device, wherein:
the gamma curve is selected from a plurality of gamma curves,
the operating mode is one of a dimmed mode or a non-dimmed mode,
when the operating mode is the dimmed mode, the selected gamma curve comprises a first value gamma curve; and
when the operating mode is the non-dimmed mode, the selected gamma curve comprises a second value gamma curve, wherein the first value is higher than the second value;
providing, by the display processing unit, code words to the display driver circuit for driving output at a display; and
converting, by the display driver circuit, the provided code words to analog signal for driving output at the display based on the selected gamma curve.

12. The method of claim 11, wherein the first value gamma curve maps a first plurality of code words to brightness levels less than a threshold and the second value gamma curve maps a second plurality of code words to brightness level less than the threshold, wherein a number of the first plurality of code words is greater than a number of the second plurality of code words.

13. The method of claim 11, wherein:
the display further comprises a fingerprint sensor in a first area of the display, and
further comprising:
determining a fingerprint verification procedure using the fingerprint sensor is in progress; and
based on determining the fingerprint verification procedure is in progress, selecting the operating mode of the computing device to be the dimmed mode.

14. The method of claim 13, further comprising:
determining the fingerprint verification procedure is complete; and
based on determining the fingerprint verification procedure is complete, selecting the operating mode of the computing device to be the non-dimmed mode.

15. The method of claim 11, wherein in the dimmed mode, a dimming layer is applied to the display, and wherein in the non-dimed mode, the dimming layer is not applied to the display.

16. The method of claim 11, wherein:
the display supports direct current dimming, and
further comprising:
determining direct current dimming of the display is in progress; and
based on determining the direct current dimming of the display is in progress, selecting the operating mode of the computing device to be the dimmed mode.

17. The method of claim 16, further comprising:
determining the direct current dimming of the display is complete; and
based on determining the direct current dimming of the display is complete, selecting the operating mode of the computing device to be the non-dimmed mode.

18. The method of claim 11, wherein the first value gamma curve is a gamma curve 4.0, and wherein the second value gamma curve is a gamma curve 2.2.

19. The method of claim 11, wherein the display processing unit is configured to provide different code words to achieve a desired brightness level of the display based on the operating mode.

20. A computing device comprising:
means for displaying;
means for converting code words to analog signals for driving output at the means for displaying;
means for providing code words to the means for converting for driving output at the means for displaying; and
means for selecting a gamma curve used by the means for converting for converting code words provided by the means for providing to brightness levels based on an operating mode of the computing device, wherein:
the gamma curve is selected from a plurality of gamma curves,
the operating mode is one of a dimmed mode or a non-dimmed mode,
when the operating mode is the dimmed mode, the selected gamma curve comprises a first value gamma curve; and
when the operating mode is the non-dimmed mode, the selected gamma curve comprises a second value gamma curve, wherein the first value is higher than the second value.

21. A non-transitory computer-readable medium that when executed by a computing device causes the computing device to perform a method of displaying images by the computing device, the method comprising:
selecting a gamma curve used by a display driver circuit for converting code words provided by a display processing unit to brightness levels based on an operating mode of the computing device, wherein:
the gamma curve is selected from a plurality of gamma curves,
the operating mode is one of a dimmed mode or a non-dimmed mode,
when the operating mode is the dimmed mode, the selected gamma curve comprises a first value gamma curve; and
when the operating mode is the non-dimmed mode, the selected gamma curve comprises a second value gamma curve, wherein the first value is higher than the second value;
providing, by the display processing unit, code words to the display driver circuit for driving output at a display; and
converting, by the display driver circuit, the provided code words to analog signal for driving output at the display based on the selected gamma curve.
